(19) United States
(12) Patent Application Publication
(10) Pub. No.: US 2007/0228957 A1
(43) Pub. Date: Oct. 4, 2007

(54) PLASMA DISPLAY MODULE AND PLASMA DISPLAY APPARATUS INCLUDING THE SAME

(75) Inventors: Kyoung-Doo Kang, Suwon-si (KR); Won-Ju Yi, Suwon-si (KR); Ho-Young Ahn, Suwon-si (KR); Dong-Young Lee, Suwon-si (KR); Soo-Ho Park, Suwon-si (KR); Seok-Gyun Woo, Suwon-si (KR); Jae-Ik Kwon, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/686,699

(22) Filed: Mar. 15, 2007

(30) Foreign Application Priority Data
Mar. 28, 2006 (KR) 2006-28076

(51) Int. Cl. H01J 17/49

(52) U.S. Cl. 313/582; 313/584

(57) ABSTRACT

A plasma display module including a substrate; barrier ribs formed on the substrate and defining a plurality of discharge cells; pairs of discharge electrodes disposed in the barrier ribs to generate a discharge in the discharge cells; a sealing layer, along with the substrate, to seal the discharge cells; phosphor layers disposed in the discharge cells; a chassis disposed in a side portion of the sealing layer to support the substrate; and a thermal conductive adhesive member disposed between the sealing layer and the substrate to transfer heat from the sealing layer to the chassis, and a plasma display apparatus including the plasma display module.

### CROSS-REFERENCE TO RELATED PATENT APPLICATION

This application claims the benefit of Korean Patent Application No. 2006-28076, filed on Mar. 28, 2006, in the Korean Intellectual Property Office, the disclosure of which is incorporated herein in its entirety by reference.

### BACKGROUND OF THE INVENTION

1. Field of the Invention

Aspects of the present invention relate to a plasma display module and plasma display apparatus comprising the plasma display module, and more particularly, to a plasma display module with a new structure including a front substrate and a sealing layer that seals a discharge gas without a rear substrate formed of glass, and a plasma display apparatus comprising the plasma display module.

2. Description of the Related Art

Plasma display panels (PDP) are flat display devices that display desired numbers, characters, or graphics by exciting phosphorescent materials of phosphor layers using ultraviolet light or radiation generated by exciting a discharge gas between two substrates on which a plurality of electrodes are formed.

PDPs are classified into DC type panels and AC type panels according to the type of a driving voltage applied to discharge cells, e.g., a discharge process. Also, PDPs are classified into facing discharge type panels and surface discharge type panels according to the arrangement of the electrodes.

All electrodes of DC type panels are exposed to discharge spaces and charges directly move between corresponding electrodes. However, at least one electrode of AC type panels is buried in a dielectric layer and charges do not directly move between corresponding electrodes—ions and electrons generated by a discharge are attached to the surface of the dielectric layer to form a wall voltage, and a discharge is sustained by a sustain voltage.

A conventional three electrode, surface discharge type PDP includes a front substrate, a rear substrate facing the front substrate, a pair of sustain-discharge electrodes (X electrodes and Y electrodes) disposed on the front substrate, a front dielectric layer to protect the pair of sustain-discharge electrodes, and a protective layer coating the front dielectric layer. Also, address electrodes are disposed on top of the rear substrate and cross the pair of sustain-discharge electrodes with a rear dielectric layer formed to protect the address electrodes. Barrier ribs are formed between the front substrate and the rear substrate and define discharge cells. And, red, green, and blue phosphor layers are formed in discharge cells. A discharge gas is injected into a space formed by combining the front substrate and the rear substrate to form discharge areas. The three electrode surface discharge type PDP is coupled to a chassis, to which a circuit board is attached, to form a plasma display module.

The three electrode surface discharge type PDP having the above structure applies an electrical signal to the Y electrodes and the address electrodes, thereby selecting specific discharge cells. An electrical signal is alternately applied to the X electrodes and the Y electrodes to generate a surface discharge from the surface of the front substrate and to produce ultraviolet radiation. The ultraviolet radiation excites the phosphor layers causing the phosphor layers to discharge visible light. The visible light is emitted from the phosphor layers of the selected discharge cells, thereby displaying a still image or moving picture.

However, the front substrate and the rear substrate of the conventional PDP are formed of expensive glass, such as PD-200 produced by Asahi Glass Co. of Japan. Since the front substrate and the rear substrate formed of the glass are necessarily several millimeters thick, the weight of the PDP cannot be decreased.

Further, as glass has a low thermal conductivity, heat generated from the PDP is not dissipated when the discharge is performed resulting in the temperature of the PDP increasing and the display quality of the PDP decreasing, such as by forming an afterimage.

### SUMMARY OF THE INVENTION

Aspects of the present invention provide a plasma display module comprising a front substrate, a sealing layer that seals a discharge gas, and a chassis coupled to a panel sealed by the sealing layer using a adhesive member without a rear substrate formed of glass, thereby reducing the temperature of the panel, and a plasma display apparatus including the plasma display module.

According to an aspect of the present invention, there is provided a plasma display module comprising: a substrate; barrier ribs formed on the substrate and to define a plurality of discharge cells; pairs of discharge electrodes disposed in the barrier ribs and to generate a discharge in the discharge cells; a sealing layer to seal the discharge cells; phosphor layers disposed in the discharge cells; a chassis disposed on a side of the sealing layer opposite the discharge cells to support the substrate; and an adhesive member disposed between the sealing layer and the chassis and to transfer heat from the sealing layer to the chassis.

The sealing layer may be adhered to the chassis via the adhesive member.

Troughs may be formed in a direction on a surface of the adhesive member that faces the sealing layer.

Troughs may be formed vertically with respect to gravity on a surface of the adhesive member facing the sealing layer.

Troughs may be formed on a direction in a surface of the adhesive member that faces the chassis.

Troughs may be formed vertically with respect to gravity on a surface of the adhesive member facing the chassis.

The adhesive member may be formed of a viscous material.

The barrier ribs may be formed of a dielectric substance containing at least one selected from a group consisting of Al₂O₃, Ca—B—SiO₂, SiO₂, BaO, and CaO.

The sealing layer may be formed of a dielectric substance containing at least one selected from a group consisting of PbO, Bi₂O₃, ZnO, SnO, RO, and SiO₂.

The sealing layer may be formed of the same material as the barrier ribs.

The sealing layer may be integrally formed with the barrier ribs.

The pairs of discharge electrodes may comprise first and second discharge electrodes that extend to cross each other.

The first and second discharge electrodes may extend to surround at least a part of the discharge cells disposed in a direction.

The pairs of discharge electrodes may comprise first and second discharge electrodes that extend parallel to each other, further comprising: address electrodes extending to cross a PDP and the pairs of discharge electrodes.

The first and second discharge electrodes may face each other toward the discharge cells.

The first and second discharge electrodes may extend to surround at least a part of the discharge cells disposed in a direction.

The address electrodes may be buried in the sealing layer.

Grooves having a predetermined depth may be formed in the substrate facing the discharge cells, and the phosphor layers may be disposed in the grooves.

According to another aspect of the present invention, there is provided a plasma display module comprising: a substrate; barrier ribs formed on the substrate to define a plurality of discharge cells; pairs of discharge electrodes disposed in the barrier ribs to generate a discharge in the discharge cells; a sealing layer to seal the discharge cells; phosphor layers disposed in the discharge cells; a chassis disposed on a side of the sealing layer opposite the barrier cells to support the substrate; and an adhesive member disposed between the sealing layer and the chassis and to adhere the sealing layer to the chassis.

The adhesive member may transfer heat from the sealing layer to the chassis.

According to another aspect of the present invention, there is provided a plasma display apparatus comprising: a plasma display module according to at least some of the above-described aspects; a front cabinet disposed in the front of the chassis to locate a display part of the plasma display module in the center of the plasma display apparatus; and a rear cabinet disposed in the rear of the plasma display module and coupled to the front cabinet.

According to another aspect of the present invention, there is provided a plasma display module, including a first substrate; a second substrate disposed to face the first substrate; barrier ribs disposed between the first substrate and the second substrate and to define a plurality of discharge cells; a chassis to support the first substrate, the barrier ribs, and the second substrate; and an adhesive member disposed on the second substrate to dissipate heat from the second substrate and to adhere the second substrate to the chassis.

According to another aspect of the present invention, there is provided a plasma display module, including a first substrate; barrier ribs to define a plurality of discharge cells; a second substrate; wherein the barrier ribs are integrally formed with the second substrate and sealed by the first substrate.

According to another aspect of the present invention, there is provided a plasma display module, including a substrate; barrier ribs to define a plurality of discharge cells; and a sealing layer formed of a material different from the substrate, wherein the barrier ribs are disposed between and sealed by the substrate and the sealing layer.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a partially exploded perspective view of a plasma display module according to aspects of the present invention;

FIG. 2 is a partially exploded perspective view of a plasma display module according to aspects of the present invention;

FIG. 3 is a cross-sectional view taken along a line III-III of FIG. 1;

FIG. 4 is a layout exploded perspective view of a plasma display apparatus including the plasma display module illustrated in FIG. 1 according to aspects of the present invention;

FIG. 5 is a partially exploded perspective view of a PDP as illustrated in FIGS. 1 through 4;

FIG. 6 is a cross-sectional view taken along a line VI-VI of FIG. 5;

FIG. 7 is a schematic layout diagram of discharge electrodes illustrated in FIG. 5;

FIG. 8 is a cross-sectional view of a PDP as illustrated in FIGS. 1 through 4;

FIG. 9 is a schematic layout diagram of discharge electrodes illustrated in FIG. 8;

FIG. 10 is a partially exploded perspective view of a PDP as illustrated in FIGS. 1 through 4; and

FIG. 11 is a partial cross-sectional view taken along a line X-X of FIG. 10.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

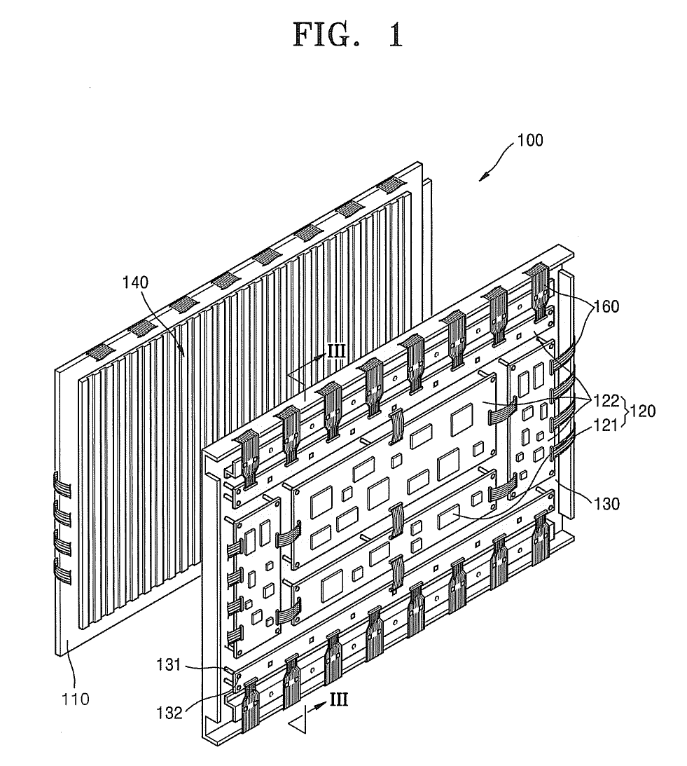

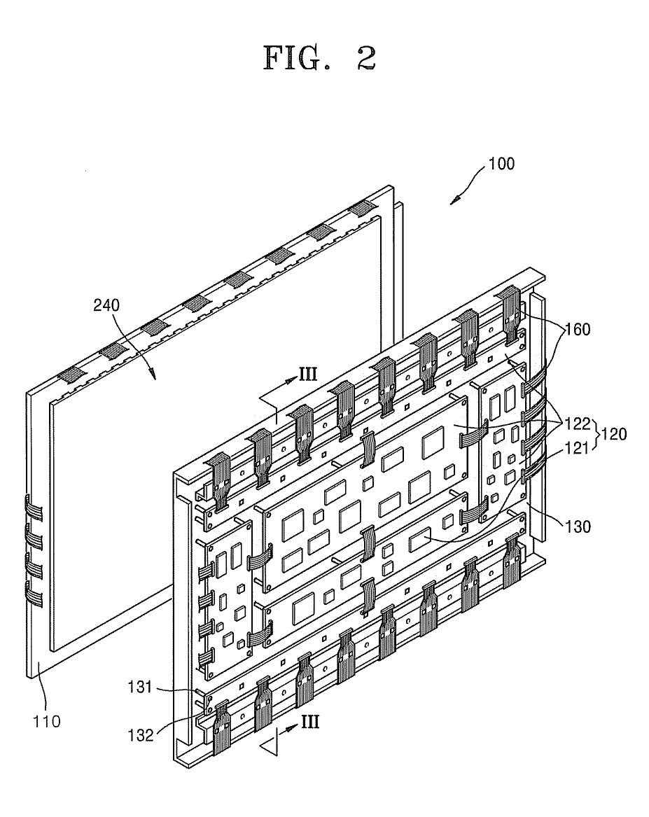

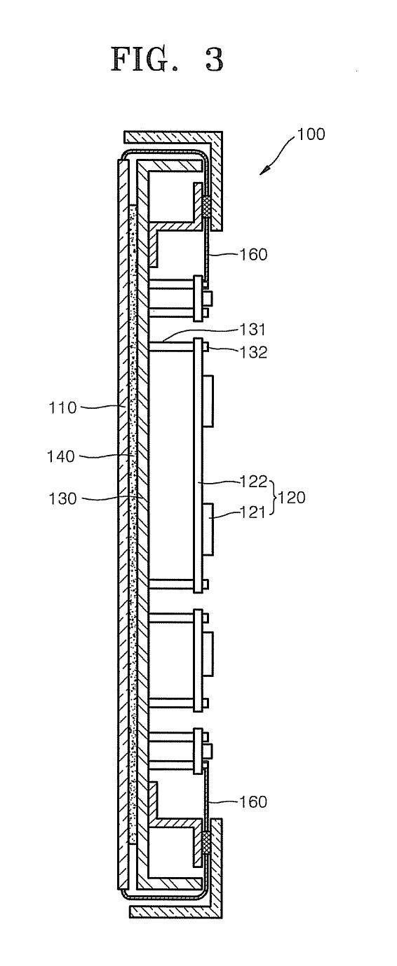

FIG. 1 is a partially exploded perspective view of a plasma display module 100 according to aspects of the present invention. FIG. 2 is a partially exploded perspective view of a plasma display module according to aspects of the present invention. FIG. 3 is a partial cross-sectional view taken along a line III-III of FIG. 1.

Referring to FIGS. 1, 2, and 3, the plasma display module 100 comprises a PDP 110, a driving apparatus 120, a chassis 130, and adhesive members 140 and 240.

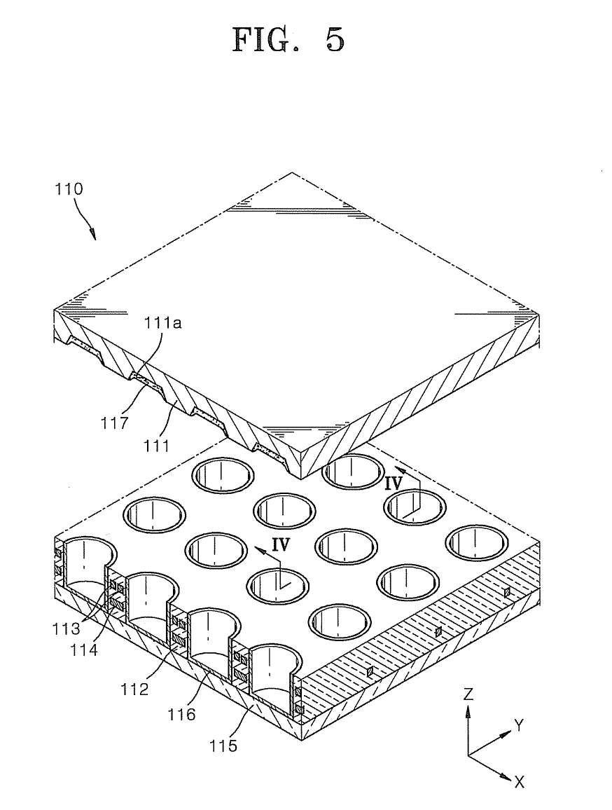

The PDP 110 that displays an image can be the PDPs as illustrated in FIGS. 5 through 11.

The driving apparatus 120 comprises circuit devices 121 and circuit boards 122 on which the circuit devices 121 are disposed. The circuit boards 122 are connectable to the chassis 130 using bosses 131 and bolts 132.

The chassis 130 is formed of a conductive steel or aluminum but the present invention is not necessarily restricted thereto. That is, the chassis 130 does not have particular restrictions regarding the material from which it is made. However, in view of the whole weight of the plasma display module 100, the chassis 130 may be formed of aluminum or a synthetic resin that is relatively light-weight and has high strength and rigidity.

The plasma display panel (PDP) 110 is adhered to a side of the chassis 130 and is supported by the chassis 130. The driving apparatus 120 is adhered to the other side of the chassis 130 and is also supported by the chassis 130.

The PDP 110 and the circuit boards 122 are electrically connected to each other using signal transfer members 160. A flexible printed cable (FPC), a tape carrier package, etc., may be used as the signal transfer members 160.

Adhesive members 140 and 240 couple the PDP 110 and the chassis 130 together, and the adhesive members 140 and 240 are thermal conductive. The adhesive members 140 and 240 are attached to a sealing layer (115 illustrated in FIG. 5) on one side of the PDP 110. A thermal conductive double-sided adhesive tape may be used for the adhesive members 140 and 240.

The adhesive members 140 and 240 are disposed between the PDP 110 and the chassis 130. In detail, the adhesive members 140 and 240 fix the PDP 110 to the chassis 130, transfer heat generated from the PDP 110 to the chassis 130, and dissipate heat the generated from the PDP 110.

The adhesive members 140 and 240 do not attach to a thick medium such as glass but directly attach the sealing layers 115, 615, and 815 as illustrated in FIGS. 5 through 11 to the chassis 130. The adhesive members 140 and 240 are formed of a viscous material. Therefore, the adhesive members 140 and 240 may be formed of a resilient, energy absorbing material rather than a hard material so that the PDP 110 can absorb and more uniformly dissipate energy. The adhesive members 140 and 240 are capable of withstanding shock without permanent deformation or rupture.

The adhesive members 140 and 240 can be formed of graphite to have a superior thermal conductivity but the present invention is not necessarily restricted thereto. The adhesive members 140 and 240 are formed of a material having a high thermal conductivity.

The adhesive members 140 and 240 are disposed between the PDP 110 and one side of the chassis 130. The adhesive members 140 and 240 may tightly contact a surface of the sealing layer 115 of FIG. 6 of the PDP 110 and a surface of the chassis 130 facing the PDP 110.

Troughs are vertically formed, with respect to gravity, in at least one surface of the adhesive members 140 and 240 and provide the adhesive members 140 and 240 with at least one side having a non-uniform surface. Although described as troughs, the toughs of the adhesive members 140 and 240 are not limited thereto. The surface of the adhesive members 140 and 240 may include cooling fins or other structures through which air may flow and heat may be efficiently dissipated. In FIG. 1, the surface of the adhesive member 140 in which troughs are formed faces the chassis 130. In FIG. 2, the surface of the adhesive member 240 in which troughs are formed faces the sealing layer of the PDP 110. The troughs can be formed on either or both surfaces of the adhesive members 140 and 240.

Each surface of the adhesive members 140 and 240 in which troughs are formed comprises a trough part, an adhesive part, and a connection part. The troughs are formed by the trough part and the connection part. The troughs are not formed in the adhesive part. The connection part is perpendicular to the surface in which the connection parts are formed so that the troughs extend into the surface at right-angles. The adhesive parts of the troughs of the adhesive members 140 adhere to the PDP 110, and the adhesive parts of the troughs of the adhesive members 240 adhere to the chassis 130. If troughs are formed in both sides of the adhesive members 140 and 240, then the adhesive parts of the double-sided adhesive member adhere to both the PDP 110 and the chassis 130.

The troughs of the adhesive members 140 and 240 extend into the surfaces in which the troughs are formed at right-angles, but the present invention is not necessarily restricted thereto. That is, the troughs of the adhesive members 140 and 240 have no particular restriction as to the shapes in which the troughs are formed if the troughs increase a surface area of the adhesive members 140 and 240 and increase the heat conductivity of the adhesive members 140 and 240.

The troughs are elongated to extend from a lower portion of the adhesive members 140 and 240 to an upper portion of the adhesive members 140 and 240 so as to facilitate the movement of air within the troughs. The air that flows in the troughs receives and removes heat from both the adhesive members 140 and 240 and the PDP 110, thereby improving the dissipation of the heat generated.

End portions of the troughs are oppositely disposed so that some of the end portions open toward the lower portion of the PDP 110 and the other end portions of the troughs are open toward the upper portion of the PDP 110. The air is heated by the PDP 110 and the adhesive members 140 and 240 and flows from the some of the end portions of the troughs at the lower portion of the PDP 110 up through the troughs and out of the other end portions of the troughs at the upper portion of the PDP 110.

The troughs are uniformly formed over the surfaces of the adhesive members 140 and 240 but are not necessarily restricted thereto. In detail, the troughs can be formed in portions of the adhesive members 140 and 240. In this case, the troughs can be formed in a portion of the adhesive members 140 and 240 where the heat of the PDP 110 is locally generated.

As described above, the plasma display module 100 includes the troughs in a surface of the adhesive members 140 and 240, thereby promptly dissipating heat generated from the PDP 110.

FIG. 3 is a cross-sectional view of the plasma display module 100 including a plasma display panel (PDP) 110, an adhesive member 140, and a chassis 130. Also, a driving apparatus 120 including circuit devices 121 adhered to circuit boards 122 is illustrated. The driving apparatus 120 is connected to the chassis via bosses 131 and bolts 132 and connected electrically to the PDP 110 via the signal transfer members 160. Here, the adhesive member 140 is adhered to both the PDP 110 and the chassis 130. The driving apparatus 120 controls the function of the PDP 110 through electrical signals supplied to the PDP 110 by the signal transfer members 160. There are many methods known for the driving of a PDP 110.

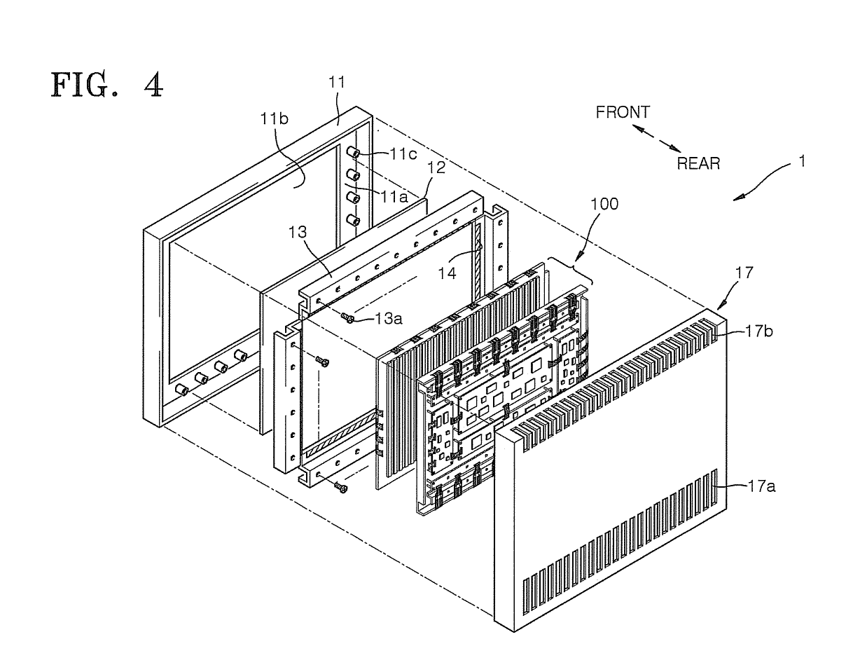

FIG. 4 is a layout exploded perspective view of a plasma display apparatus 1 including the plasma display module illustrated in FIG. 1 according to aspects of the present invention.

Referring to FIG. 4, the plasma display apparatus 1 comprises the plasma display module 100 illustrated in FIGS. 1 through 3. The plasma display apparatus 1 comprises a front cabinet 11 including a window 11b disposed in the middle thereof, an electromagnetic wave blocking filter 12 disposed in the rear of the front cabinet 11 and covering the rear of the window 11b. Also, a filter holder 13 to hold the electromagnetic wave blocking filter 12 to the rear of the window 11b is connected to a peripheral part 11a of the front cabinet 11. The PDP 100 and the chassis 130 are disposed to the rear of the filter holder 13, and the chassis 130 supports the PDP 110. The chassis 130, as described above, includes a driving circuit part 120 formed in the rear of the chassis 130 which drives the PDP 100. And, a rear cabinet 17 is disposed in the rear of the plasma display apparatus 1 and coupled to the front cabinet 11. The rear cabinet 17 may include vents 17a and 17b. The vents 17a are formed at a lower portion of the rear cabinet 17, and the vents 17b are formed at an upper portion of the rear cabinet 17. The vents 17a and 17b allow air into the front cabinet 11 and the rear cabinet 17, when the front cabinet 11 and the rear cabinet 17 are coupled. However, the vents 17a and 17b are not limited thereto.

The electromagnetic wave blocking filter 12 is tightly adhered to the rear side of the front cabinet 11 using the filter holder 13 that is coupled to screw locking parts 11c via screws 13a. The plasma display module 100 is tightly adhered to an elastic body 14 attached to the rear side of the filter holder 13. The elastic body 14 absorbs energy and reduces shock transferred to the PDP 110 of the plasma display module 100. The driving circuit part 120 driving the PDP 110 is coupled to the chassis 130 and drives the PDP 110 using the signal transfer member 160 such as the FPC.

The rear side of the PDP 110 is coupled to the chassis 130 via the adhesive members 140 and 240, which have a superior thermal conductivity to dissipate heat generated from the PDP 110. The rear cabinet 17 couples to the front cabinet 11 to house the electromagnetic wave blocking filter 12, the filter holder 13, and the plasma display module 100.

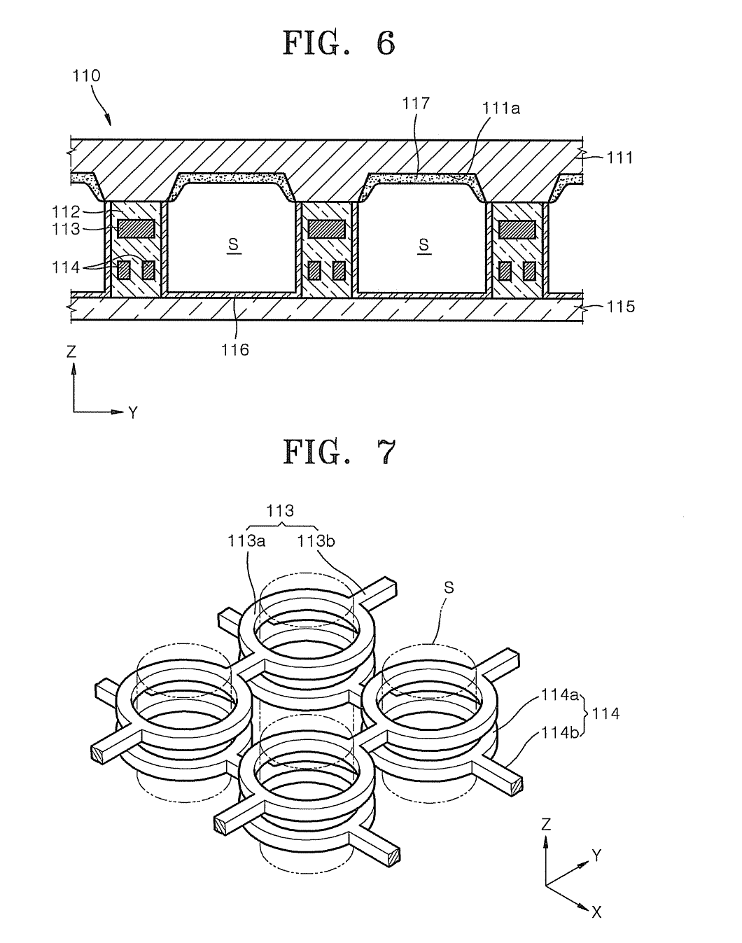

FIG. 5 is a partially exploded perspective view of a PDP 110 illustrated in FIGS. 1 through 4 according to aspects of the present invention. FIG. 6 is a cross-sectional view taken along a line VI-VI of FIG. 5. FIG. 7 is a schematic layout diagram of discharge electrodes illustrated in FIG. 5.

Referring to FIGS. 5 through 7, the PDP 110 includes a substrate 111. The substrate 111 is normally formed of a material having excellent light transmission properties such as glass. However, the substrate 111 can be colored or translucent in order to increase the bright room contrast by reducing reflective brightness when the display is viewed in a bright room.

Barrier ribs 112 are formed between the substrate 111 and the sealing layer to define discharge cells S and to prevent electrical and optical cross talk between the adjacent discharge cells S. Pluralities of discharge electrodes 113 and 114 are buried in the barrier ribs 112.

The barrier ribs 112 prevent direct conduction between the first discharge electrodes 113 and the second discharge electrodes 114. The barrier ribs 112 also prevent positive ions from directly colliding with and damaging the first discharge electrodes 113 and the second discharge electrodes 114. Also, the barrier ribs 112 accumulate wall charges because of electric flow therein. Accordingly, the barrier ribs 112 may be formed of a dielectric substance. The barrier ribs 112 include a first dielectric material containing at least one selected from a group consisting of Al₂O₃, Ca—B—SiO₂, SiO₂, BaO, and CaO.

The discharge cells S defined by the barrier ribs 112 have circular cross sections, but the present invention is not limited thereto. That is, the barrier ribs 112 can have a variety of patterns to define the discharge cells S. For example, the discharge cells S may have polygonal cross sections such as triangular cross sections, tetragonal cross sections, pentagonal cross sections, etc., or non-circular cross sections. The discharge cells S can have delta-type, waffle-type, or meander-type arrangements.

The first discharge electrodes 113 and the second discharge electrodes 114 are disposed in the barrier ribs 112 and spaced apart from each other in a direction perpendicular to the substrate 111; or, the first discharge electrodes 113 and the second discharge electrodes 114 are disposed in the barrier ribs 112 and separated in a direction of the shortest distance from the sealing layer 115 to the substrate 111. The first discharge electrodes 113 are disposed closer to the substrate 111 than the second discharge electrodes 114. The second discharge electrodes 114 are disposed closer to the sealing layer 115 than the first discharge electrodes 113. However, the first discharge electrodes 113 and the second discharge electrodes 114 are limited thereto.

Referring specifically to FIG. 7, the first discharge electrodes 113 extend in a direction Y and are disposed to surround the discharge cells S. The first discharge electrodes 113 comprise first loops 113a, and first bridges 113b electrically connecting the first loops 113a.

The first loops 113a are closed circular loops but the present invention is not restricted thereto. The first loops 113a can have various shapes such as tetragonal or hexagonal, open or closed loops, and may have the substantially the same shape as the cross sections of the discharge cells S.

The second discharge electrodes 114 extend in a direction X and are disposed to surround the discharge cells S. The second discharge electrodes 114 cross the first discharge electrodes 113. The second discharge electrodes 114 are separated from the first discharge electrodes 113 in a direction Z in the barrier ribs 112.

The second discharge electrodes 114 comprise second loops 114a surrounding the discharge cells S and second bridges 114b electrically connecting the second loops 114a.

The second loops 114a are closed circular loops but are not restricted thereto. The second loops 114a can have various shapes such as tetragonal or hexagonal, open loops or closed loops, and may have the substantially the same shape as the cross sections of the discharge cells S.

Since the first discharge electrodes 113 and the second discharge electrodes 114 are not disposed on the substrate 111, they do not reduce the transmission rate of the visible light generated by the phosphorescent materials in the phosphor layer 117. As the first discharge electrodes 113 and the second discharge electrodes 114 are disposed in the barrier ribs, the first discharge electrodes 113 and the second discharge electrodes 114 can be formed of a conductive metal such as aluminum, copper, etc.

The PDP 110 according to aspects of the present invention has a two-electrode structure including the first discharge electrodes 113 and the second discharge electrodes 114. Accordingly, either the first discharge electrodes 113 or the second discharge electrodes 114 can serve as scan and sustain electrodes, and the other of the first discharge electrodes 113 and the second discharge electrodes 114 can serve as address and sustain electrodes.

Referring back to FIGS. 5 and 6, a sealing layer 115 is formed at the lower part of the barrier ribs 112, opposite the phosphor layers 117. The sealing layer 115 is coupled to the substrate 111 and seals a discharge gas injected into the discharge cells S. The upper surface of the sealing layer 115 is tightly adhered to the bottom surface of the barrier ribs 112.

The sealing layer 115 is formed of a second dielectric material different from the first dielectric material of the barrier ribs 112. The second dielectric material may contain at least one selected from a group consisting of PbO, Bi₂O₃, ZnO, SnO, and SiO₂, which have a small thermal deformation and form substantially flat sheets when baked. The second dielectric material of the sealing layer 115 may occupy at least 30 wt % of the total composition of the sealing layer 115. If the second dielectric material is less than 30 wt %, the sealing layer 115 may be transformed by the heat generated by the PDP 110 and becomes difficult to sufficiently flatten. However, the sealing layer 115 may be formed of the same material as the barrier ribs 112, and the barrier ribs 112 and the sealing layer 115 may be integrally formed.

The sealing layer 115 can be formed with the barrier ribs 112 through the same baking process or can be coupled to the barrier ribs 112 through a sealing process where two individual baking processes, one to form the sealing layer 115 and one to form the barrier ribs 112, occur and the individually-formed sealing layer 115 and the individually-formed barrier ribs 112 are sealed.

Protective layer 116 can be formed in at least one portion of the sidewalls of the barrier ribs 112 or the surface of the sealing layer 115 corresponding to the discharge cells S. The protective layers 116 prevent the barrier ribs 114 formed of the first dielectric substance and the first and second discharge electrodes 113 and 114 from being damaged due to sputtering of plasma particles. Also, the protective layers 116 generate secondary electrons to reduce discharge voltage. The protective layers 116 can be formed of magnesium oxide (MgO).

The adhesive members 140 and 240 directly transfer heat generated by the PDP 110 to the chassis 130 from the sealing layer 115 instead of a glass substrate that has a low thermal conductivity. Thus, the heat generated by the discharge of a discharge cell S in the PDP 110 is effectively dissipated. Therefore, the temperature of the PDP 110 can be reduced and the display quality can be improved so as to prevent the display of an afterimage.

Grooves 111a with a predetermined depth are formed in the substrate 111 facing each of the discharge cells S. The grooves 111a are formed to correspond to each of the discharge cells S. The grooves 111a have substantially the same shape as the discharge cells S.

Red, green, and blue phosphor layers 117 are formed in the grooves 111a. Alternatively, the phosphor layers 117 can be formed in a different region. For example, the phosphor layers 117 can be formed on the barrier ribs 112 on the inner sidewalls of the discharge cells or the surface of the sealing layer 115 that corresponds to the discharge cell.

The phosphor layers 117 have a component that generates visible light from ultraviolet radiation. That is, the phosphor layer 117 formed in a red light-emitting discharge cell S has a phosphor such as Y(V,P)O₄:Eu; a phosphor layer formed in a green light-emitting discharge cell S has a phosphor such as Zn₂SiO₄:Mn, YBO₃:Tb; and a phosphor layer formed in a blue light-emitting discharge cell S has a phosphor such as BAM:Eu. So, the discharge in the discharge cell S excites electrons of the discharge gas that, when returning to an original energy level, emit ultraviolet photons, which in turn excite electrons of the phosphors of the phosphor layers 117. For example, in a red light-emitting discharge cell S, the electrons of the red light-emitting phosphor will be excited by the ultraviolet radiation and, when returning to an original energy state, will emit light in the red portion of the visible spectrum.

A discharge gas such as Ne, Xe, or a mixture thereof is sealed in the discharge cells S. As the first discharge electrodes 113 and the second discharge electrodes 114 are disposed in the barrier ribs 112, the discharge surface increases and the discharge area can be expanded, meaning that the cross-sectional area of the discharge cells S is increased and there are fewer elements formed on the substrate 111 to inhibit the emitted light's travel therethrough. Essentially, such configuration increases a discharge density as the cross-sectional area of the discharge cell per display area is increased. As the cross-sectional area of the discharge cells S increases, the amount of plasma generated by a discharge is increased, so that the PDP 110 can be operated at a low voltage. Therefore, despite using a gas like Xe that has a high density as the discharge gas, the PDP 110 can be operated at the low voltage, thereby remarkably increasing luminous efficiency. The efficiency of the PDP 110 is further increased by disposing the first and the second discharge electrodes 113 and 114 in the barrier ribs 112 and forming the barrier ribs 112 from a dielectric material as the first and the second discharge electrodes 113 and 114 need not be transparent, so a metal having a lower resistance may be used.

A method of operating the PDP 110 having the above structure will now be described.

The address discharge is generated between the first discharge electrodes 113 and the second discharge electrodes 114 to select the discharge cells S in which the sustain discharge is generated. If a sustain voltage is applied between the first discharge electrodes 113 and the second discharge electrodes 114 of the selected discharge cells S, the sustain discharge is generated between the first discharge electrodes 113 and the second discharge electrodes 114. The sustain discharge excites electrons of the contained discharge gas which then reduce in energy and emit ultraviolet light. The ultraviolet light excites the electrons in the phosphor layers 117, and as the energy level of the excited electrons of the phosphor layers 117 is reduced, visible light is emitted. The PDP 110 is driven so as to form an image from the emitted visible light.

The PDP 110 according to aspects of the present invention has a relatively large discharge area due to the sustain discharge generated on all perimeters defining the discharge cells S instead of the sustain discharge being generated on only one side of the discharge cells S.

Also, the sustain discharge of the PDP 110 may form a closed curve along the sidewalls of the discharge cells S, and the sustain discharge gradually extend to the center of each of the discharge cells S. Accordingly, the size of the sustain discharge area increases, and space charges of the discharge cells S contribute to light-emission, thereby improving luminous efficiency of the PDP 110. In particular, since the discharge cells S have circular cross sections, the sustain discharge is uniformly generated in all perimeters of the discharge cells S.

Also, the sustain discharge is generated mainly at the center of each of the discharge cells S, which prevents ion sputtering of the phosphor layers 117 due to the charged particles. Accordingly, image sticking does not occur even when an image is displayed for a long time.

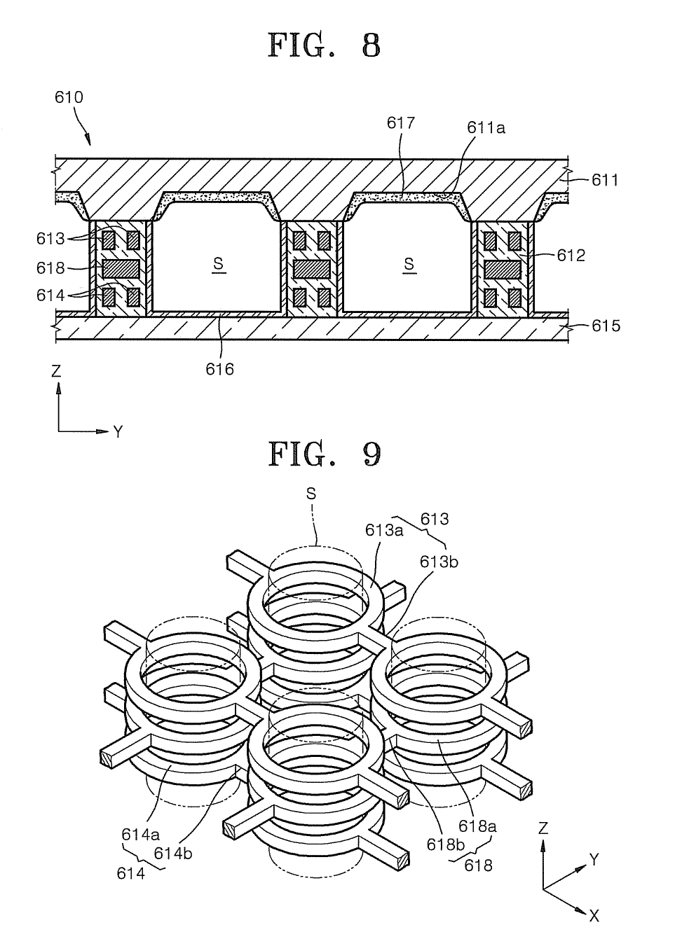

FIG. 8 is a cross-sectional view of a plasma display panel (PDP) 610 that may be used in a plasma display module similar to the plasma display module 100 as illustrated in FIGS. 1 through 4. FIG. 9 is a schematic layout diagram of the discharge electrodes for the PDP 610 as illustrated in FIG. 8.

Referring to FIG. 8, the PDP 610 comprises a substrate 611, and a sealing layer 615 that is thinner than the substrate 611. The substrate 611 and the sealing layer 615 face each other. Barrier ribs 612 define discharge cells S and are disposed between the substrate 611 and the sealing layer 615.

First, second, and third discharge electrodes 613, 614, and 618, respectively, are formed in the barrier ribs 612. The first discharge electrodes 613 are disposed closer to the substrate 611 than the second and third discharge electrodes 614 and 618. The second discharge electrodes 614 are disposed closer to the sealing layer 615 than the first and third discharge electrodes 613 and 618. The third discharge electrodes 618 are disposed between the first and second discharge electrodes 613 and 614. The third discharge electrodes 618 may be disposed in the barrier ribs 612 to correspond with a central portion of the discharge cells S.

The first and second discharge electrodes 613 and 614 correspond to X electrodes and Y electrodes, respectively, and make pairs with regard to each of the discharge cells S. The first discharge electrodes 613 and the second discharge electrodes 614 generate a sustain discharge and extend parallel to each other. With regard to FIG. 9, the first discharge electrodes 613 comprise first loops 613a that surround each of the discharge cells S and first bridges 613b to electrically connect the first loops 613a. The second discharge electrodes 614 comprise second loops 614a that surround each of the discharge cells S, and second bridges 614b to electrically connect the second loops 614a. The first discharge electrodes 613 and the second discharge electrodes 614 both extend in the X direction.

The third discharge electrodes 618 cross the first discharge electrodes 613 and the second discharge electrodes 614 and are address electrodes that generate an address discharge with the second discharge electrodes 614. The third discharge electrodes 618 comprise third loops 618a that surround each of the discharge cells S, and third bridges 618b to electrically connect the third loops 618a. The third discharge electrodes 618 extend in the Y direction and cross the first discharge electrodes 613 and the second discharge electrodes 614.

The first discharge electrodes 613, the third discharge electrodes 618, and the second discharge electrodes 614 are sequentially disposed in a direction Z to reduce the address discharge voltage, but the present invention is not limited thereto. That is, the third discharge electrodes 618 to which an address voltage is applied can be disposed closest to the substrate 611, or farthest from the substrate 611, and can be formed in the sealing layer 615.

The third discharge electrodes 618 generate an address discharge in order to more easily perform a sustain discharge between the first discharge electrodes 613 and the second discharge electrodes 614, and more particularly, to reduce a voltage required to start the sustain discharge.

The address discharge is generated between the second discharge electrodes 614, which correspond to the Y electrodes of the conventional PDP, and the third discharge electrodes 618 correspond to the address electrodes. When the address discharge is finished, positive ions are accumulated on the second discharge electrodes 614, and electrons are accumulated on the first discharge electrodes 613, and the sustain discharge is easily performed between the first discharge electrodes 613 and the second discharge electrodes 614.

The first, second, and third discharge electrodes 613, 614, and 618, respectively, are not disposed in or on the substrate 611 and are formed of metal that is an excellent conductor and has a low resistance. The first, second, and third discharge electrodes 613, 614, and 618, respectively, can be formed of a metal such as aluminum.

As illustrated in FIG. 8, the barrier ribs 612 are formed of a first dielectric material containing at least one material selected from a group consisting of Al₂O₃, Ca—B—SiO₂, SiO₂, BaO, and CaO. The sealing layer 615 is formed of a second dielectric material containing at least one material selected from a group consisting of PbO, Bi₂O₃, ZnO, SnO, and SiO₂ that do not readily deform in response to heat and can be formed into a substantially flat sheet. The sealing layer 615 contains at least 30 wt % of the second dielectric material. However, the sealing layer 615 can be formed of the same material of the barrier ribs 612.

Protective layers 617 are disposed in the sidewalls of the barrier ribs 612 and/or the portions of the inner surface of the sealing layer 615 that correspond to the discharge cells S. The protective layers are generally formed of magnesium oxide (MgO). A plurality of grooves 611a is formed in portions corresponding to the discharge cells S in the substrate 611. Red, green, and blue phosphor layers 617 are formed in the grooves 611a.

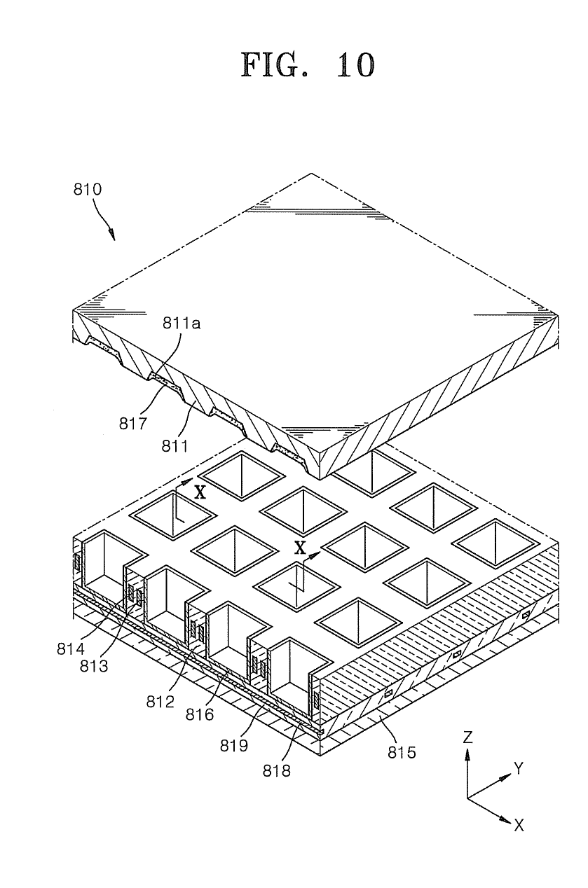

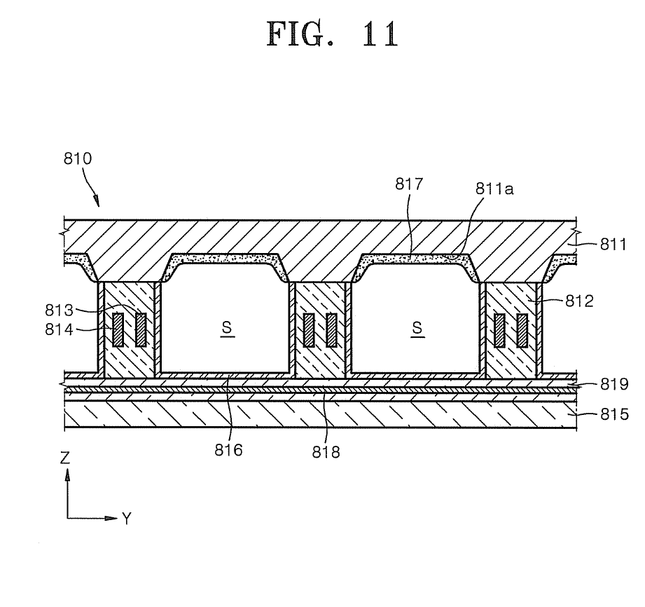

FIG. 10 is a partially exploded perspective view of a plasma display panel (PDP) 810 for use in a plasma display module similar to the plasma display module 100 as illustrated in FIGS. 1 through 4. FIG. 11 is a partial cross-sectional view taken along a line X-X of FIG. 10.

Referring to FIGS. 10 and 11, the PDP 810 includes a substrate 811. The substrate 811 is transparent, translucent, or can be colored.

Barrier ribs 812 are disposed between the substrate 811 and a sealing layer 815 to define discharge cells S. The barrier ribs 812 are matrix-shaped to define the discharge cells having tetragonal cross-sections but the present invention is not limited thereto. The barrier ribs 812 are formed of a first dielectric material containing at least one material selected from a group consisting of Al₂O₃, Ca—B—SiO₂, SiO₂, BaO, and CaO.

First and second discharge electrodes 813 and 814 are disposed in the barrier ribs 812. The first and second discharge electrodes 813 and 814 can have a surface discharge type structure as illustrated in FIG. 1, or an opposed discharge type structure. Here, the plasma display panel 810 has the opposed discharge type structure but the present invention is not limited thereto. The first and second discharge electrodes 813 and 814 make pairs with regard to each of the discharge cells S and generate a discharge in the discharge cells S. The first and second discharge electrodes 813 and 814 extend in a direction Y and are separated from each other toward the center of the discharge cells S in a direction X. The first and second discharge electrodes 813 and 814 effect the discharge across the discharge cells S so that the discharge can be uniformly generated in the discharge cells S.

A sealing layer 815 is formed opposite the substrate 811 with the barrier ribs 812 disposed therebetween. The sealing layer 815 is formed of a second dielectric material containing at least one material selected from a group consisting of PbO, Bi₂O₃, ZnO, SnO, and SiO₂ that deform very little in response to heat and can form a substantially flat sheet when baked. The sealing layer 815 includes at least 30 wt % of the second dielectric material.

A dielectric layer 819 is disposed between the barrier ribs 812 and the sealing layer 815. The upper surface of the dielectric layer 819 tightly contacts the lower surface of the barrier ribs 812. Although the dielectric layer 819 can be formed of various dielectric materials, the dielectric layer 819 may be formed of the same material as that of the barrier ribs 812.

The barrier ribs 812, the sealing layer 815, and the dielectric layer 819 can be individually formed through individual baking processes and sealed together, or the barrier ribs 812, the sealing layer 815, and the dielectric 819 can be integrally formed in the same baking process.

Third discharge electrodes 818 are disposed in the dielectric layer 819, extend in a direction X of the PDP 800. The third discharge electrodes 818 are disposed to cross the first and second discharge electrodes 813 and 814, which extend in the direction Y The first and second discharge electrodes 813 and 814 correspond to X electrodes and Y electrodes, respectively, of the conventional PDP and generate a sustain discharge. The third discharge electrodes 818 are address electrodes that generate an address discharge along with the second discharge electrodes 814.

Protective layer 816 can be formed on the inner sidewalls of the barrier ribs 812 or the inner surface of the dielectric layer 819. The protective layers 816 can be formed by coating the surfaces with magnesium oxide (MgO) at a predetermined thickness.

A plurality of grooves 811a is formed in the substrate 811 corresponding to each of the discharge cells, S and the grooves 811a have a predetermined depth. The grooves 811a are formed in portions of the substrate 811 to correspond to each of the discharge cells S and contain phosphor layers 817. A discharge gas such as Ne, Xe, or a mixture thereof is sealed in the discharge cells S.

A method of operating the PDP 800 having the above structure will now be described.

The address discharge is generated between the second discharge electrodes 814, which correspond to the Y electrodes, and the third discharge electrodes 818, which are the address electrodes, so as to select the discharge cells S in which the sustain discharge is generated.

If a sustain voltage is applied between the first discharge electrodes 813, which correspond to the X electrodes, and the second discharge electrodes 814 of the selected discharge cells S, the sustain discharge is generated between the first discharge electrodes 813 and the second discharge electrodes 814. The sustain discharge excites electrons of the discharge gas, which increase to a higher energy state and decrease back to an original energy state. Upon decreasing in energy, the electrons emit ultraviolet radiation or light, which excites the phosphorescent materials of the phosphor layers 817. Upon excitement, electrons in the phosphorescent materials of the phosphorescent layers 817 increase in energy and then decrease back to the original energy state. Upon decreasing in energy, the electrons of the phosphorescent materials of the phosphorescent layers 817 emit light or photons in the visible spectrum. The color of the light emitted from the phosphor layers 817 is determined by the type of phosphor contained therein and the wavelength of the light emitted. The phosphors are arranged and excited so as to form an image in the visible spectrum.

According to the plasma display module and the plasma display apparatus including the plasma display module of the present invention, a panel sealed by a sealing layer and a chassis are coupled to each other via adhesive members, thereby reducing the temperature of the panel.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A plasma display module comprising:
a substrate;
barrier ribs formed on the substrate to define a plurality of discharge cells;
pairs of discharge electrodes disposed in the barrier ribs to generate a discharge in the discharge cells;
a sealing layer to seal the discharge cells;
phosphor layers disposed in the discharge cells;
a chassis disposed on a side of the sealing layer opposite the discharge cells to support the substrate; and
a thermal conductive adhesive member disposed between the sealing layer and the chassis to transfer heat from the sealing layer to the chassis.

2. The plasma display module of claim 1, wherein the sealing layer is adhered to the chassis via the adhesive member.

3. The plasma display module of claim 1, wherein troughs are formed on a surface of the adhesive member that faces the sealing layer.

4. The plasma display module of claim 3, wherein the troughs are formed vertically with respect to gravity.

5. The plasma display module of claim 1, wherein troughs are formed on a surface of the adhesive member that faces the chassis.

6. The plasma display module of claim 5, wherein the troughs are formed vertically with respect to gravity.

7. The plasma display module of claim 1, wherein the adhesive member is formed of a viscous material.

8. The plasma display module of claim 1, wherein the barrier ribs are formed of a dielectric substance containing at least one material selected from a group consisting of Al₂O₃, Ca—B—SiO₂, SiO₂, BaO, and CaO.

9. The plasma display module of claim 1, wherein the sealing layer is formed of a dielectric substance containing at least one material selected from a group consisting of PbO, Bi₂O₃, ZnO, SnO, RO, and SiO₂.

10. The plasma display module of claim 1, wherein the sealing layer is formed of the same material as the barrier ribs.

11. The plasma display module of claim 1, wherein the sealing layer is integrally formed with the barrier ribs.

12. The plasma display module of claim 1, wherein the pairs of discharge electrodes comprise first and second discharge electrodes that cross each other.

13. The plasma display module of claim 1, wherein the pairs of discharge electrodes comprise first and second discharge electrodes, and
the first and second discharge electrodes surround at least a part of the discharge cells disposed in a direction.

14. The plasma display module of claim 1, further comprising:
address electrodes that cross the pairs of discharge electrodes; and
the pairs of discharge electrodes comprise first and second discharge electrodes that extend parallel to each other.

15. The plasma display module of claim 1, wherein the pairs of discharge electrodes comprise first and second discharge electrodes, and
the first and second discharge electrodes effect a discharge across the discharge cells.

16. The plasma display module of claim 14, wherein the first and second discharge electrodes surround at least a part of the discharge cells.

17. The plasma display module of claim 14, wherein the address electrodes are buried in the sealing layer.

18. The plasma display module of claim 1, wherein grooves having a predetermined depth are formed in the substrate facing the discharge cells, and the phosphor layers are disposed in the grooves.

19. A plasma display module comprising:
a substrate;
barrier ribs formed on the substrate to define a plurality of discharge cells;
pairs of discharge electrodes disposed in the barrier ribs to generate a discharge in the discharge cells;
a sealing layer to seal the discharge cells;
phosphor layers disposed in the discharge cells;
a chassis disposed on a side of the sealing layer opposite the barrier cells to support the substrate; and
a thermal conductive adhesive member disposed between the sealing layer and the chassis to adhere the sealing layer to the chassis.

20. The plasma display module of claim 19, wherein the adhesive member transfers heat from the sealing layer to the chassis.

21. The plasma display module of claim 19, wherein troughs are formed on a surface of the adhesive member facing the sealing layer.

22. The plasma display module of claim 21, wherein the troughs are formed vertically with respect to gravity.

23. The plasma display module of claim 19, wherein troughs are formed on a surface of the adhesive member facing the chassis.

24. The plasma display module of claim 23, wherein the troughs are formed vertically with respect to gravity.

25. The plasma display module of claim 19, wherein the adhesive member is formed of a viscous material.

26. The plasma display module of claim 19, wherein the sealing layer is integrally formed with the barrier ribs.

27. A plasma display apparatus comprising:
a plasma display module as in claim 1;
a front cabinet disposed in the front of the chassis to locate a display part of the plasma display module in the center of the plasma display apparatus; and
a rear cabinet disposed in the rear of the plasma display module and coupled to the front cabinet.
